(19) United States
(12) Patent Application Publication
(10) Pub. No.: US 2001/0008466 A1
(43) Pub. Date: Jul. 19, 2001

(54) Method for fabricating apodized optical fiber grating using amplitude mask

(75) Inventors: Heu-Gon Kim, Songnam-shi (KR); Ju-Nyung Jang, Seoul (KR); Sang-Gil Shin, Suwon-shi (KR); Min-Sung Kim, Songnam-shi (KR)

Correspondence Address: KLAUBER & JACKSON, 411 HACKENSACK AVENUE, HACKENSACK, NJ, 07601

(73) Assignee: SAMSUNG ELECTRONIC CO., LTD.

(21) Appl. No.: 09/750,576

(22) Filed: Dec. 28, 2000

(30) Foreign Application Priority Data
Dec. 28, 1999 (KR) 1999-64122

(51) Int. Cl. G02B 5/20; F21V 9/06; G02B 5/18; G02B 27/44

(52) U.S. Cl. 359/566; 359/361

(57) ABSTRACT

Disclosed is a fabrication method of an apodized optical fiber grating. The method according to the invention uses an ultraviolet light source for outputting an ultraviolet layer, a lens field for converging or emitting the light incident from the ultraviolet light source, an amplitude mask for selectively transmitting the ultraviolet layer incident from the lens field, and an optical fiber, on which the light that has transmitted the amplitude mask. Accordingly, the method includes a first step of setting a cycle of the optical fiber grating formed on the optical fiber and a width of each stripe pattern, a second step of setting a longitudinal ratio, which is a ratio of the distance between the converging or emitting point of the lens field and the amplitude mask to the distance between the converging or emitting point of the lens field and the optical fiber, a third step of setting a cycle of the amplitude mask so as to unify a transverse ratio, which is a ratio of the cycle of the amplitude mask to the cycle of the optical fiber grating, with the longitudinal ratio set in the second step, and a fourth step of setting a thickness of the amplitude mask so as to match the pattern of the optical fiber grating set in the first step with the pattern of an optical distribution on the injecting surface of the mask.

### CLAIM OF PRIORITY

This application claims priority to an application entitled “Fabrication Method of Apodized Optical Fiber Grating Using Amplitude Mask” filed with the Korean Industrial Property Office on Dec. 28, 1999 and there duly assigned Ser. No. 99-64122.

### BACKGROUND OF THE INVENTION

1. Field of the Invention

The present invention relates to an optical fiber grating, and in particular, to a method of fabricating an apodized optical fiber grating by controlling the thickness of an amplitude mask.

2. Description of the Related Art

Waveguide gratings are typically fabricated by doping a waveguide core layer with photosensitive dopants. When appropriate wavelength light is illuminated on the optical fibers, typically germanium doped fiber, the index of refraction of the core layer is changed. The appropriate periodic spacing of the perturbation to achieve varying index of refraction is obtained by the use of a phase mask or an amplitude mask. In a phase mask scheme, an external ultraviolet lazer illuminates the fiber though a thin flat slab of silica with a pattern of fine parallel troughs etched on its bottom. It diffracts most of the light in two directions where they generate an interference pattern covering the fiber.

In contrast, the amplitude mask selectively transmits the ultraviolet layer through a slit without diffraction as the width of the slit in the amplitude mask is relatively greater than a wavelength of the ultraviolet layer. In general, the grating formed on the optical fiber using the amplitude mask converts the optical signal proceeded with a core mode within the optical fiber to a clad mode so as to weaken the optical signal. An optical fiber grating with regular refractive index amplitude and grating cycle with respect to the entire length of the grating is referred as a uniform optical fiber grating.

FIG. 1 is a graph showing an extinction ratio curve of the uniform fiber grating according to varying wavelengths. The curve consists of a main lobe with a peak bandwidth and adjacent side lobes. The loss curve with respect to the uniform optical fiber grating of a regular length typically has a series of side lobes adjacent to the mid-wavelength. The side lobes in the drawing correspond to noise in terms of an injection of the optical fiber grating. Accordingly, the side lobes should be eliminated to enhance the output characteristics of the optical fiber grating. Such elimination of the side lobes is called an “apodizing”, and an optical fiber grating on which the apodizing has been realized, is called an “apodized optical fiber grating.”

FIG. 2 is a block diagram showing an apparatus for fabricating an apodized optical fiber grating using a conventional piezoelectric device. Referring to FIG. 2, an ultraviolet light source 21 moves along the phase mask 23 at a regular speed while applying an ultraviolet light onto the phase mask 23. The incident ultraviolet layer is refracted by the phase mask 23. While the interference pattern of the ±1^{st} refracted lights is being applied to the optical fiber 24 to form a grating, the piezoelectric elements 22 moves along the longitudinal direction of the fiber so that the light illumination onto the fiber is exposed by a different amount. For example, the piezoelectric elements 22 can move toward each other at an increment so that a part of the light exposed to the fiber is blocked while the other part not that is not being blocked can be exposed to the light longer period. The voltage on the piezoelectric elements 22 is supplied by the voltage supply 25. However, the fabricating method described above has some drawbacks in that the movement of the piezoelectric elements 22 has to be controlled precisely to obtain the desired fiber grating.

### SUMMARY OF THE INVENTION

It is, therefore, an object of the present invention to provide a method of fabricating an apodized optical fiber grating without the need of a precise control device.

To achieve the above object, there is provided a method of fabricating an apodized optical fiber grating using an ultraviolet light source which includes a means for outputting an ultraviolet light; a lens field for converging or emitting the light incident from the ultraviolet light source; an amplitude mask for selectively transmitting the ultraviolet layer incident from the lens field; and, an optical fiber for receiving the light transmitted via the amplitude mask.

Accordingly, the method according to the present invention includes the following steps of: a first step of setting the cycle of the optical fiber grating formed on the optical fiber and the width of each stripe pattern; a second step of setting a longitudinal ratio, which is a ratio of the distance between the converging (or emitting point) of the lens field and the amplitude mask, to the distance between the converging (or emitting point) of the lens field and the optical fiber; a third step of setting the cycle of the amplitude mask so as to unify a transverse ratio, which is a ratio of the cycle of the amplitude mask to the cycle of the optical fiber grating, with the longitudinal ratio set in the second step; and, a fourth step of setting a thickness of the amplitude mask so as to match the pattern of the optical fiber grating set in the first step with the pattern of an optical distribution on the injecting surface of the mask.

### BRIEF DESCRIPTION OF THE DRAWINGS

The above and other objects, features, and advantages of the present invention will become more apparent from the following detailed description when taken in conjunction with the accompanying drawings, in which:

FIG. 1 is a graph illustrating the extinction ratios of the uniform grating in accordance with wavelengths;

FIG. 2 is a block diagram illustrating an apparatus of fabricating an apodized optical fiber by using a conventional piezoelectric element;

FIG. 3 is a diagram illustrating a method of fabricating an apodized optical fiber grating using an amplitude mask according to a preferred embodiment of the present invention;

FIG. 4 is a perspective view of the amplitude mask shown in FIG. 3;

FIG. 5 is a partial sectional view illustrating the process of forming the apodized optical fiber grating using the apparatus as shown in FIG. 3;

FIG. 6 is a side elevational view illustrating the process of adjusting a converging or emitting point of the lens field as shown in FIG. 3;

FIG. 7 is a partial sectional view illustrating the process of forming the optical fiber grating by the apparatus shown in FIG. 6;

FIG. 8 is a partial sectional view illustrating the process of adjusting the apodizing degree of the optical fiber grating shown in FIG. 5 by using the thickness of the amplitude mask;

FIGS. 9a and 9b are diagrams illustrating apodizing degrees of the optical fiber grating according to the present invention; and,

FIG. 10 is a chart illustrating the extinction ratios of the apodized optical fiber grating in accordance with wavelengths according to the present invention.

### DETAILED DESCRIPTION OF THE PREFERRED EMBODIMENTS

A preferred embodiment of the present invention will be described herein below with reference to the accompanying drawings. For the purpose of clarity, well-known functions or constructions are not described in detail since they would obscure the invention in unnecessary detail.

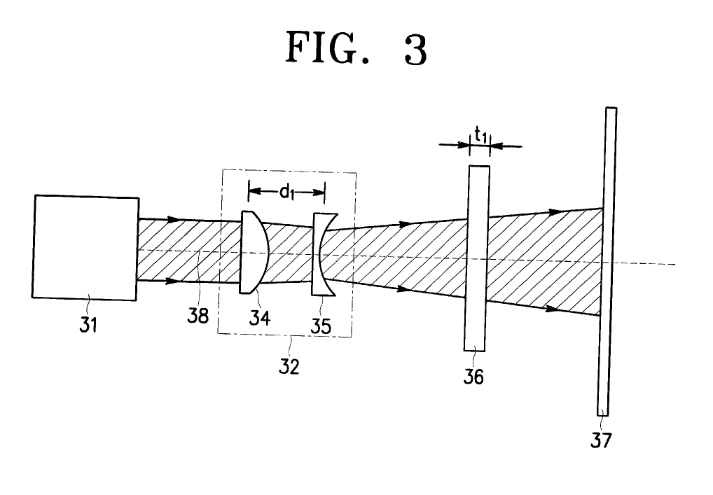

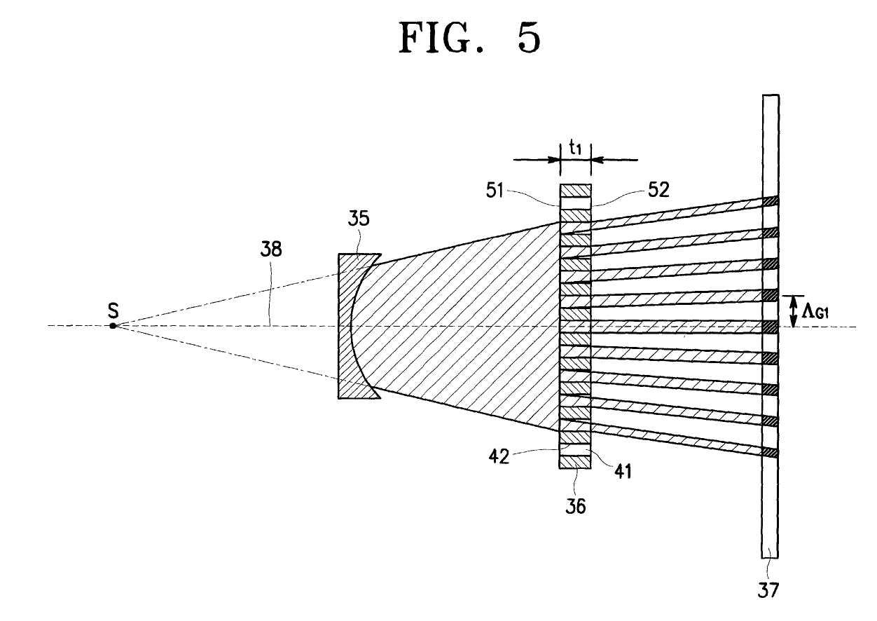

FIG. 3 is a diagram illustrating the method of fabricating an apodized optical fiber grating using an amplitude mask according to the preferred embodiment of the present invention. Referring to FIG. 3, an ultraviolet source 31 illuminates light to be applied to the lens field 32. The ultraviolet light source 31 includes an excimer laser. The lens field 32 includes a plain-convex lens 34 and a plain-concave lens 35 spaced apart by length d1. When the light is emitted from the ultraviolet source 31 through the lens field 32, the light emitted from the ultraviolet light source 31 appears as if the light is generated from a single converging point, as shown in FIG. 5. Here, the point where the light injected from the lens field 32 looks converged is sometimes referred to as a “converging point.” Alternatively, the same point, from which the light injected from the lens field 32 is emitted is sometimes referred to an “emitting point.”

In the embodiment of the present invention, the light transmitted through the lens field 32 is incident on an optical fiber 37 after passing the amplitude mask 36 with a thickness of t₁. Accordingly, stripe patterns, referred to as gratings, of the amplitude mask 36 are formed along the length of the photosensitive optical fiber 37. An optical axis 38 represented by dotted lines in FIG. 3 represents a reference axis that is used to reference the major components of the present invention. Accordingly, all elements described in the preceding paragraphs have a rotational symmetry with respect to the optical axis 38.

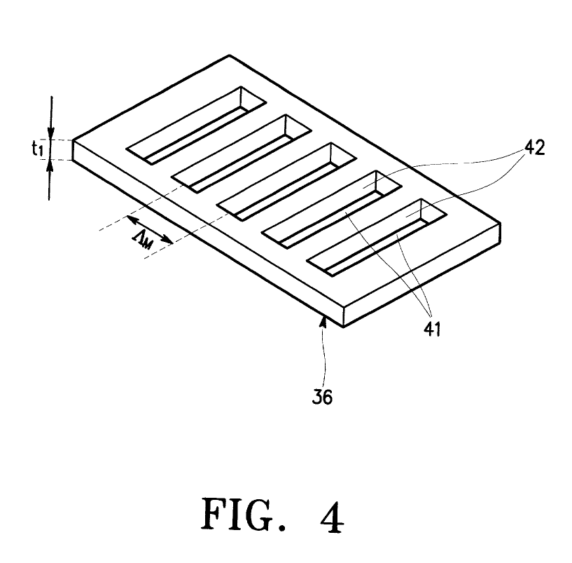

FIG. 4 is a perspective view of the amplitude mask 36 shown in FIG. 3. According to the present invention, the amplitude ask 36 includes a plurality of slits 41 arranged in a row with a uniform cycle period of ^_{M} between each slit 41. The slit 41 has a width of ^_{M}/2, which is the same numerical unit as the distance between the slits 41. The amplitude mask 36 has a thickness of t₁, and the inner wall 42 constituting the slits 41 also has the thickness of t₁. Since the width of the slit 41 is relatively greater than the wavelength of the incident light, the light incident on the amplitude mask 36 typically transmits through the slits 41 without any refraction. Thereafter, the transmitted light via the amplitude mask 36 is incident along the optical fiber 37, as shown in FIG. 3, and then changes the refractive index along the length of the optical fiber 37. Accordingly, the periodic variations in refractive index formed on the optical fiber 37 serve as fiber gratings.

FIG. 5 is a partial sectional view illustrating the process of forming the apodized optical fiber grating using the apparatus shown in FIG. 3. For simplicity, FIG. 5 illustrates a projected view of the light eliminated from the light source 31 starting from a plain-concave lens 35, which corresponds to the last element of the lens field 32 shown in FIG. 3. As described earlier, the light injected to the plain-concave lens 35 will behave as if the light is generated from an emitting point S, and the generated light is illuminated onto the amplitude mask 36 with the thickness of t₁. The amplitude mask 36 includes an incident surface 51, through which the light is incident, and an injecting surface 52, through which the light is being transmitted.

As shown in FIG. 5, the light incident on the amplitude mask 36 is transmitted through the slits 41. As each slit 41 is position away from the optical axis 38, the width of the projected light along the optical fiber 37 becomes narrower. Although light transmitted through each slit 41 is uniformly distributed at first, the incident light after passing through each slit 41 exhibit different characteristics as each slit 41 passing the same light is elevated at different angle relative to the emitting point S. Referring to FIG. 5, some portion of the light illuminated onto the incident surface 51 of the amplitude mask 35 is blocked or extinguished while passing through the inner wall 42 of the slit 41 due to both the thickness of the amplitude mask 35 and the higher elevation angle of the slits 41 relative to the emitting point S. Accordingly, the width of the light projected from each slit 41 through the injecting surface 52 of the amplitude mask 36 becomes narrower for the corresponding light projected from the slits 41 that are positioned away from the optical axis 38. At the same time, the stripe pattern constituting the optical fiber grating along the length of the optical fiber 37 becomes a gradually narrower as the projected light from the stripe pattern positioned away from the optical axis 38 tend to become narrower. The apodized optical fiber grating produced via the above process has an almost regular cycle of ^_{G1}.

According to the present invention, the method of fabricating apodized optical fiber using the amplitude mask 36 is initially set to have varying illuminated width along the optical fiber 37 at with variation cycle of ^_{G1} between each grating formed on the fiber 37. Thereafter, the method further involves the following steps.

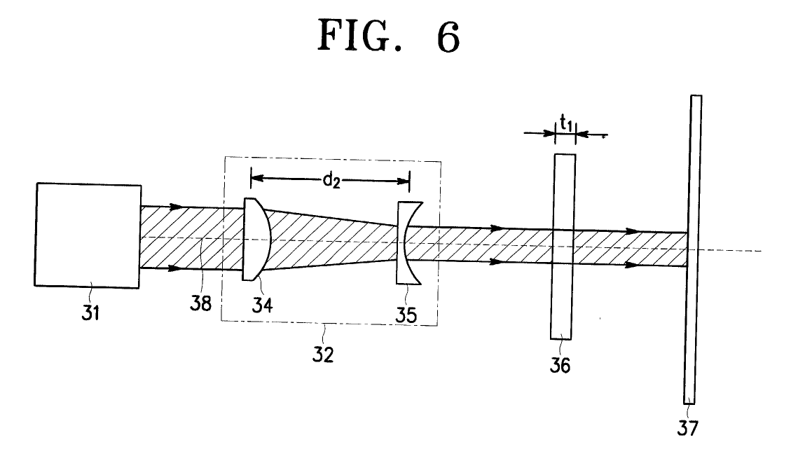

First, after setting a specific width and regular cycle of the gratings formed along the optical fiber 37 as described above, the second step is directed to setting an optimal longitudinal ratio. Referring to FIG. 6, the longitudinal ratio represents the ratio of the distance between the converging (or emitting point) of the lens field 32 and the amplitude mask 36, to the distance between the converging (or emitting point) and the optical fiber 37. FIG. 6 is a side elevational view illustrating the process of adjusting the converging (or emitting point) of the lens field 32. As shown in FIG. 6, by adjusting the distance d₂ in the lens field 32, the light projected from the lens field 32 can be arranged to be parallel with the optical axis 38. In particular, the adjustment of the projected light is accomplishes by adjusting the distance between two lenses 34 and 35 of the optical field 32. In the first step, the distance between the two lenses 34 and 35 was d₁ as shown in FIG. 3, now that distance is adjusted to d₂ as shown in FIG. 6. However, the thickness of the amplitude mask 36 remained constant.

The third step is directed to adjusting the cycle of the amplitude mask 36 between the slits 41 to produce a uniform transverse ratio, which corresponds to the cycle of the amplitude mask 36 and the cycle of the optical fiber grating, while maintaining the longitudinal ratio set in the second step.

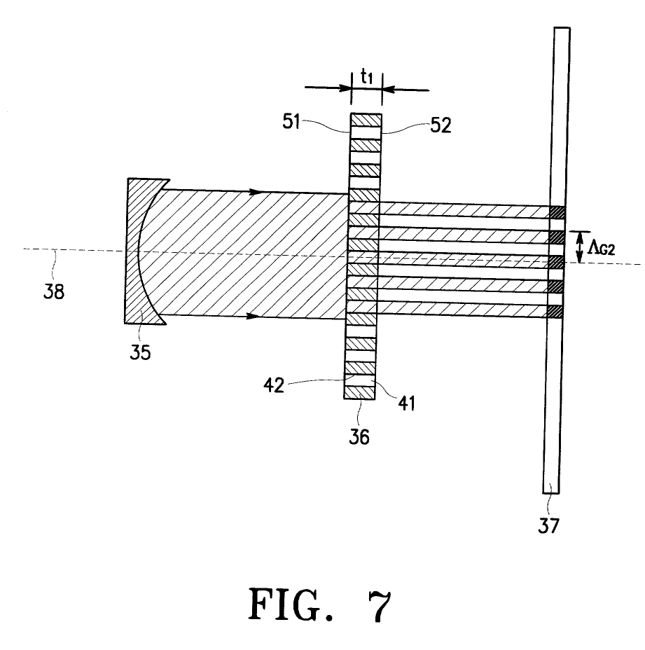

FIG. 7 is a partial sectional view illustrating the process of forming the optical fiber grating by the apparatus in FIG. 6.

For the purpose of clarity, FIG. 7 illustrates view starting from the plain-concave lens 35, which is the last element of the optical field 32 shown in FIG. 6. Unlike FIG. 5, the light projected through the plain-concave lens 35 has a uniform parallel projection onto the optical fiber 38 along the optical axis 38. As shown in FIG. 7, the inner walls 42 of the slits 41 are in parallel relationship with the optical axis 38 along the amplitude mask 36. Accordingly, any of the uniform light incident through the slit 41 is not blocked by the inner wall 42 of the respective slit 41 as the light pass through the amplitude mask 36. In particular, the width of the light projected through each slit 41 along the injecting surface 52 of the amplitude mask 36 does not become narrower even if some of the slits 41 is position distance from the optical axis 38 as in the first step. As a result, the widths of grating stripe patterns formed along the optical fiber 37 through the light projected through the amplitude mask 36 have identical width, as shown in FIG. 7.

It should be noted that the second step and third steps can be executed in any order in the present invention. Thus, it is not only possible to decide the cycle of the amplitude mask in the third step after setting the longitudinal ratio in the second step, but also it is also possible to adjust the distance between the converging (or emitting point) of the lens field and the amplitude mask as well as the distance between the converging (or emitting point) of the lens field and the optical fiber after setting the transverse ratio. Thus, if the distance between the amplitude mask 36 and the optical fiber 37 is fixed, the distance between the converging (or emitting point) of the lens field and the amplitude mask 36 can be adjusted to meet the target transverse ratio. Here, the lens field is composed of a cylindrical convex lens and a concave lens. Hence, the converging (or emitting point) can be adjusted by varying the distance between the cylindrical convex lens and the concave lens.

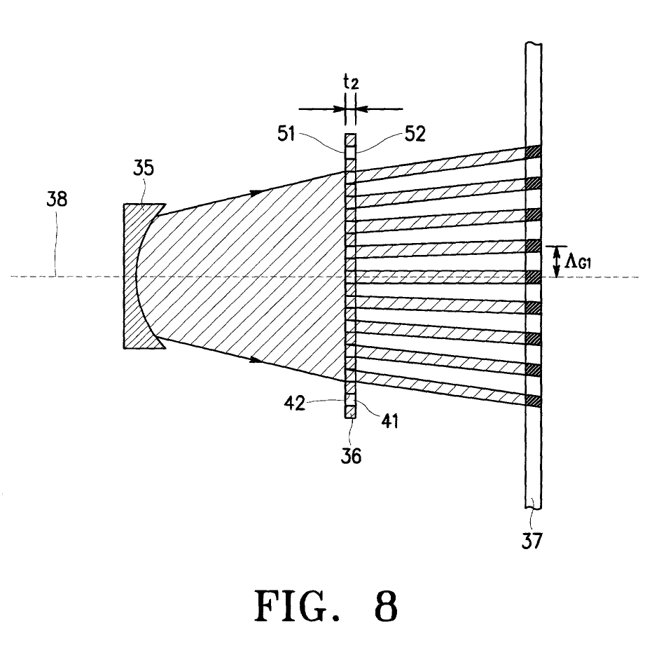

The fourth step is directed to adjusting the thickness of the amplitude mask 36 so that the wavelength of each pattern of the optical fiber grating set in the first step is now matched with the pattern of the optical distribution on the injecting surface of the mask 36. Thus, the width of strip pattern obtained near the reference axis 38 in the first step is duplicated, then further illumination of light can be exposed to a narrower region along the fiber so that continued change in the index of refraction is performed along the fiber. That is, by adjusting the thickness of the mask, as shown in FIG. 8, the shape of the apodized optical fiber grating can be conformed to that of the optical distribution on the injecting surface of the amplitude mask 36. Unlike the conventional method of fabricating uniform optical fiber grating, the width of the light injected from each slit on the injecting surface of the amplitude mask is not narrowed even if each slit becomes distant from the optical axis, as shown in FIG. 8. The main reason lies in setting the thickness of the amplitude mask. FIG. 8 is a partial sectional view illustrating the process of adjusting the apodizing degree of the optical fiber grating in FIG. 5 by using the thickness of the amplitude mask. FIG. 8 shows the same apparatus as that of FIG. 5, except it shows slimmer amplitude mask 36.

Referring to FIG. 8, the amplitude mask 36, to which the light injected from the plain-concave lens 35 is incident, has a thickness of t₂. The width of the light projected through the injecting surface 52 of the amplitude mask 36 is slightly variable even if the slit 41 becomes distant from the optical axis 38. Such a phenomenon is attributable to the fact that the area where the light incident on the slit 41 crosses the inner wall 42 thereof is reduced even if the angle formed by the light incident on the slit 41 with respect to the optical axis 38 is the same as before varying the thickness of the amplitude mask 36. Thus, the apodizing degree of the optical fiber grating according to the present invention is varied by adjusting the thickness of the amplitude mask 36.

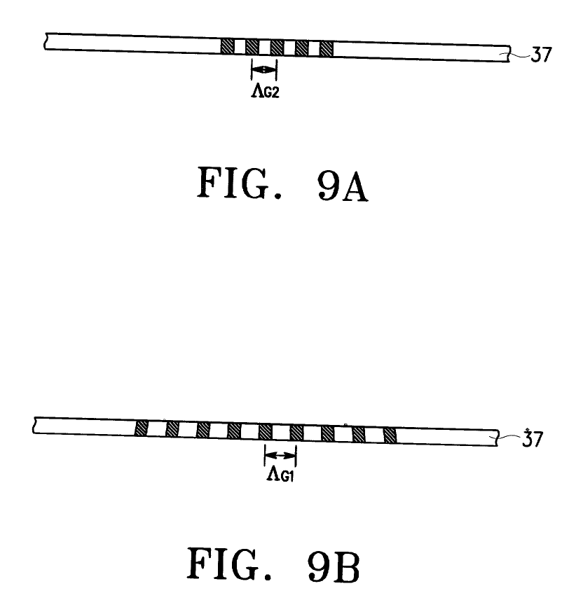

FIGS. 9a and 9b are diagrams illustrating apodizing degrees of the optical fiber grating according to the present invention. FIG. 9a shows the optical fiber 37 in FIG. 7, while FIG. 9b shows the optical fiber 37 in FIG. 8.

Conventionally, the apodization of an optical fiber grating can be realized by varying the modulation widths of the refractive index of the stripe patterns constituting the optical fiber grating in accordance with the positions thereof. By contrast, the apodization of an optical fiber grating according to the present invention is realized by varying the widths of the stripe patterns constituting the optical fiber grating in accordance with the positions thereof.

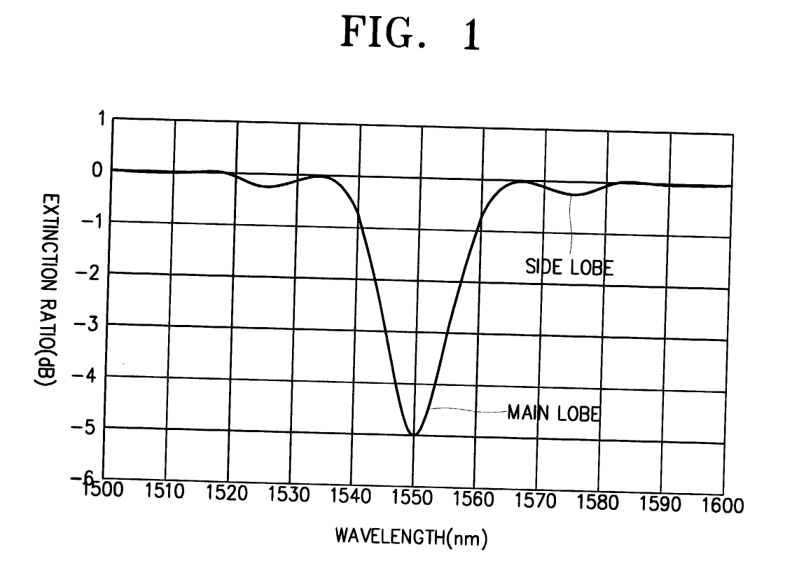

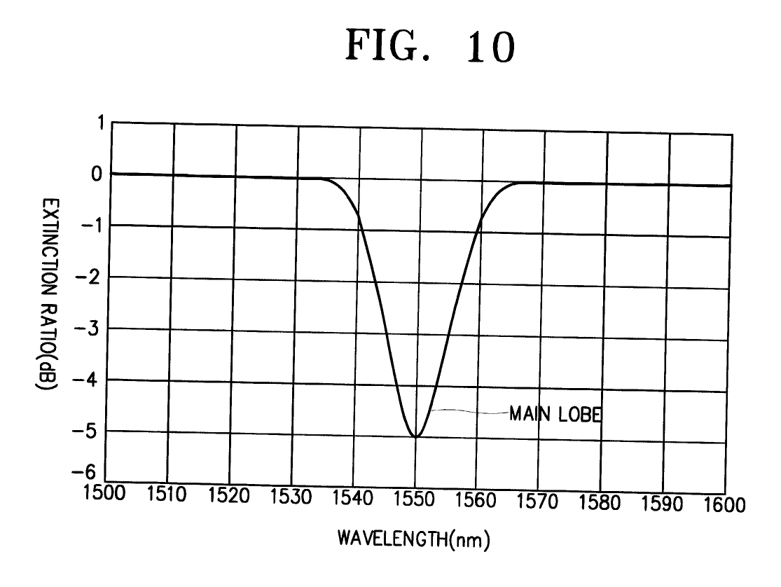

FIG. 10 is a chart illustrating a curve of extinction ratios of the apodized optical fiber grating in accordance with wavelengths according to the present invention. FIG. 10 shows that the side lobes shown in FIG. 1 have been almost extinguished.

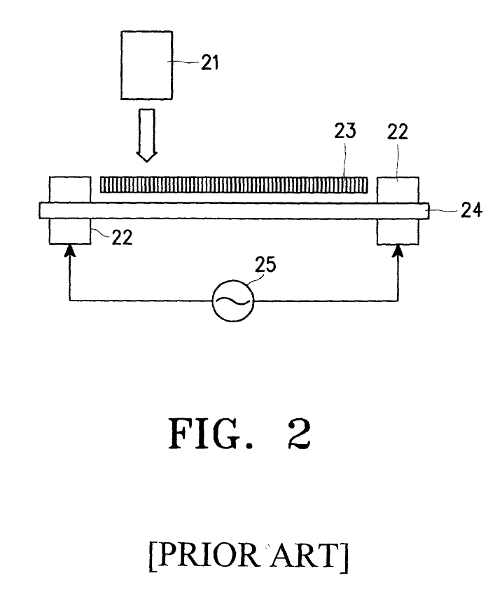

The fabrication method of apodized optical fiber grating according to the present invention has an advantage of easily realizing the apodization without precisely controlling the timing and movement of the light blocking devices (i.e., piezoelectric elements 22 of FIG. 2) by controlling the thickness of the amplitude mask.

While the invention has been shown and described with reference to a certain preferred embodiment thereof, it will be understood by those skilled in the art that various changes in form and details may be made therein without departing from the spirit and the scope of the invention as defined by the appended claims.

What is claimed is:

1. A method for fabricating an apodized optical fiber grating using an ultraviolet light source, a lens field for converging the light incident from the ultraviolet light source, an amplitude mask for selectively transmitting therethrough the ultraviolet light incident from the lens field onto an optical fiber, the method comprising the steps of:
a first step of setting a cycle of the optical fiber grating formed on the optical fiber and a width of each stripe pattern;
a second step of setting a longitudinal ratio, which is a ratio of the distance between a converging point of the lens field and the amplitude mask and the distance between the converging point of the lens field and the optical fiber;
a third step of setting a cycle of the amplitude mask so as to unify a transverse ratio, which is a ratio of the cycle of the amplitude mask and the cycle of the optical fiber grating, with the longitudinal ratio set in the second step; and
a fourth step of setting a thickness of the amplitude mask so as to match the pattern of the optical fiber grating set in the first step with the pattern of an optical distribution on the injecting surface of the mask.

2. The fabrication method of claim 1, wherein the ultraviolet light source is an excimer laser.

3. The method of claim 1, wherein the lens field consists of at least one cylindrical convex lens and at least one concave lens.

4. The method of claim 3, wherein the converging point of the lens field is adjusted by selectively varying the distance between the cylindrical convex lens and concave lens.

5. The method of claim 1, wherein the first step further comprises the step of exposing the ultraviolet light through the amplitude mask.

6. The method of claim 1, wherein the fourth step further comprises the step of exposing the ultraviolet light through the amplitude mask.

7. The method of claim 1, wherein the slit width of the amplitude mask is substantially greater than the wavelength of the incident light transmitted from the lens field.
